(19) United States
(12) Patent Application Publication
(10) Pub. No.: US 2017/0278614 A1
(43) Pub. Date: Sep. 28, 2017

(54) Magnetic Core, Inductive Component, And Method For Producing A Magnetic Core

(71) Applicant: Würth Elektronik Eisos GmbH & Co. KG, Waldenburg (DE)

(72) Inventors: Alexander GERFER, Odenthal (DE); Dragan DINULOVIC, München (DE)

(21) Appl. No.: 15/506,985

(22) PCT Filed: Aug. 6, 2015
(86) PCT No.: PCT/EP2015/068180

§ 371 Date: Feb. 27, 2017

(30) Foreign Application Priority Data
Sep. 10, 2014 (DE) 10 2014 218 043.0

(51) Int. Cl. H01F 10/12; H01F 10/14; H01F 10/13; H01F 3/10; H01F 27/26

(52) U.S. Cl. CPC H01F 10/12; H01F 3/10; H01F 27/263; H01F 10/131; H01F 10/132; H01F 10/14; H01F 2003/106

(57) ABSTRACT

A magnetic core for an inductive component is produced by thin-film technology, wherein the magnetic core consists of at least two different magnetic materials.

The invention relates to a magnetic core for an inductive component, produced by thin-film technology. The invention also relates to a method for producing a magnetic core by thin-film technology.

International patent publication WO 2013/072135 A1 discloses an inductive component, produced by thin-film technology, which includes a magnetic core in the form of a ring and two coil devices. The magnetic core is produced by means of thin-film technology from a single, magnetic material.

The Japanese Patent abstract JP 2012-278322 A discloses a magnetic core in the form of a slit circular ring, which has an inner core and an outer core. The outer core has a number of layers of an amorphous magnetic material, an insulating film and an insulation layer between the amorphous magnetic material and the insulating film. The inner Magnetic core is made up of a number of layers of the amorphous magnetic material and an insulating film. The individual layers of the amorphous magnetic material both in the inner core and in the outer core are always separated from one another by a layer of the insulating film.

With the invention it is intended to improve a magnetic core for an inductive component and a method for producing a magnetic core by means of thin-film technology.

Provided for this purpose according to the invention is a magnetic core for an inductive component that is produced by thin-film technology, wherein the magnetic core consists at least two different magnetic materials.

It has surprisingly been found that the use of at least two different magnetic materials in the production of a magnetic core by thin-film technology allows the saturation behavior of the magnetic core to be improved. It is especially possible to specifically influence the saturation behavior of the magnetic core, so that it can be set optimally for the application intended.

In a development of the invention, the different magnetic materials alternate over the length of the magnetic core.

Seen over its circumference, the magnetic core consequently consists of a number of portions that consist of different magnetic materials.

In a development of the invention, the different magnetic materials respectively take up the full cross section of the magnetic core.

The different portions of the magnetic core consequently consist completely of a single magnetic material and are, figuratively speaking, fitted one inside the other, in order then to form the complete magnetic core.

In a development of the invention, the different magnetic materials respectively extend over the entire length of the magnetic core.

According to one embodiment of the invention, a number of portions of different magnetic material are not provided in the longitudinal direction of the magnetic core but in the transverse direction. For example, a number of layers of different magnetic materials are laid one on top of the other in order to form the complete magnetic core.

In a development of the invention, a cross section of the magnetic core is formed from different magnetic materials.

In a development of the invention, the magnetic core forms a closed ring, the ring having a circular, oval, elliptical, square or rectangular form.

A square or rectangular form may in this case have pointed or else rounded corners. The form of the magnetic core influences the inductance of the finished inductive component, and can consequently be chosen according to the intended application purpose.

In a development of the invention, the magnetic core is formed by means of at least an outer ring of a first magnetic material and an inner ring of a second magnetic material.

In this way, the desired saturation behavior of the magnetic core can be set, for example by the thickness of the outer ring and the inner ring and also by the choice of the first magnetic material and the second magnetic material.

In a development of the invention, the different magnetic materials are selected from the materials Ni, NiFe, CoFe, CoP and CoZrTi.

These materials have proven to be successful in the production of magnetic cores by thin-film technology and have different magnetic properties, so that according to the invention any desired saturation behavior of the magnetic core can be set.

In a development of the invention, a coil surrounding the magnetic core in certain portions is produced by means of thin-film technology.

In this way, not just the magnetic core but the complete inductive component can be produced by means of thin-film technology.

The problem addressed by the invention is also solved by a method for producing a magnetic core, wherein the application of a first magnetic material to a substrate by means of thin-film technology and the application of a second magnetic material to the substrate by means of thin-film technology are envisaged, the first magnetic material being directly adjacent to the second magnetic material at least in certain portions.

The method according to the invention allows a magnetic core to be produced by thin-film technology and at the same time allows the desired properties of the magnetic core, specifically its saturation behavior, to be set by choosing different magnetic materials and also the dimensions of the portions of the magnetic core of the different materials.

In a development of the invention, the first magnetic material is applied to the substrate in the form of a first closed ring and the second material is applied to the substrate in the form of a second closed ring, the second closed ring being directly adjacent to the first closed ring with one side.

Seen over the cross section of the magnetic core, the first material and the second material consequently alternate. However, a complete ring is formed by each of the two different magnetic materials, the rings lying at least with one side directly against one another.

In a development of the invention, the application of a portion of a coil winding to the substrate by thin-film technology is envisaged, after which the application of the first and second material to form the magnetic core is envisaged and after which again the application of further portions of the coil winding is then envisaged, so that the finished coil winding surrounds the magnetic core in certain portions.

In this way, the complete inductive component including the magnetic core and coils can be produced by means of thin-film technology.

Further features and advantages of the invention emerge from the claims and the following description of preferred embodiments of the invention in conjunction with the drawings. Individual features of the various embodiments represented can be combined with one another in any way desired without going beyond the scope of the invention. In the drawings:

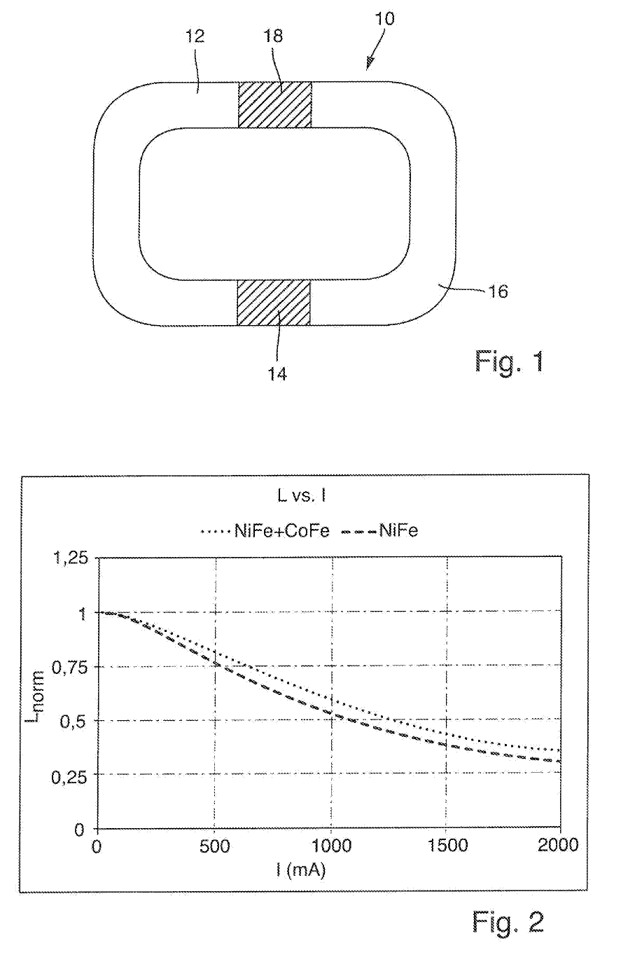

FIG. 1 shows a schematic view of a magnetic core according to a first embodiment of the invention,

FIG. 2 shows a diagram of a normalized inductance of a coil with the magnetic core of FIG. 1 against the current consumption,

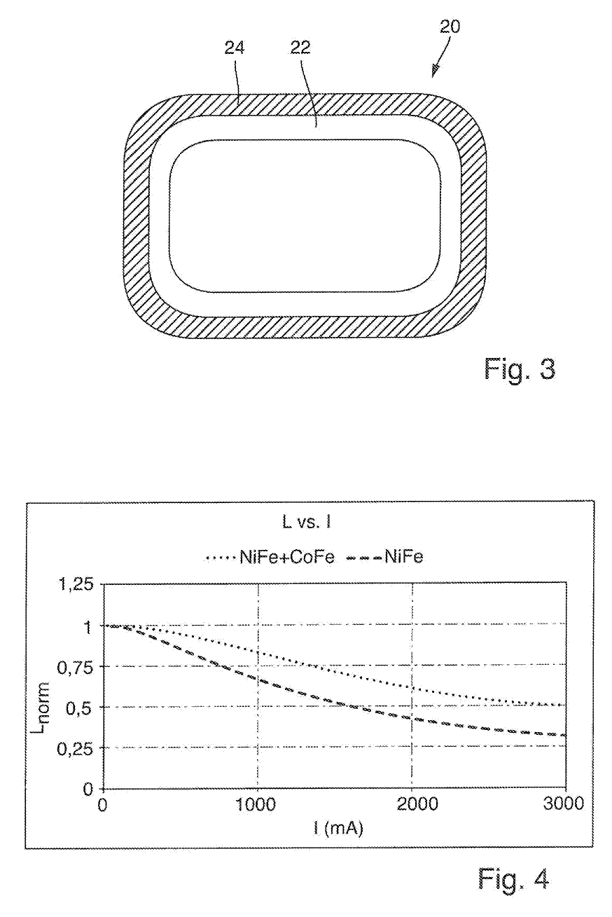

FIG. 3 shows a schematic representation of a magnetic core according to a further embodiment of the invention,

FIG. 4 shows a diagram of the normalized inductance of a coil with the magnetic core of FIG. 3 against the current consumption,

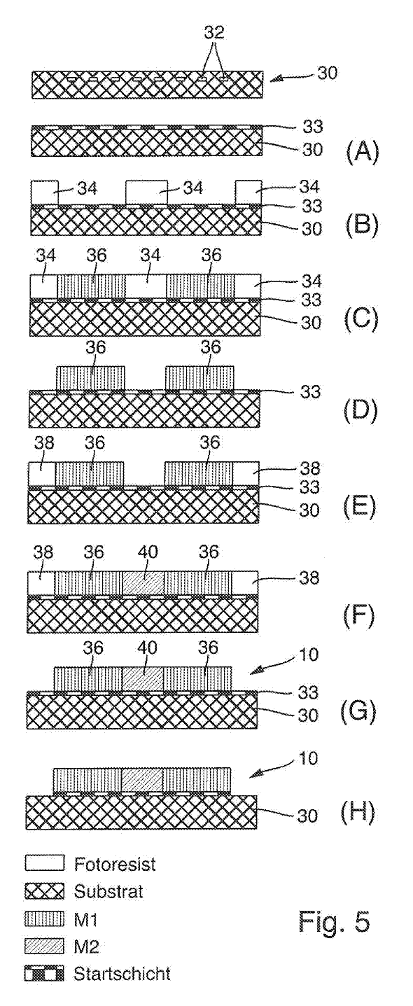

FIG. 5 shows a schematic representation of the method steps in the production of the magnetic core of FIG. 1 and

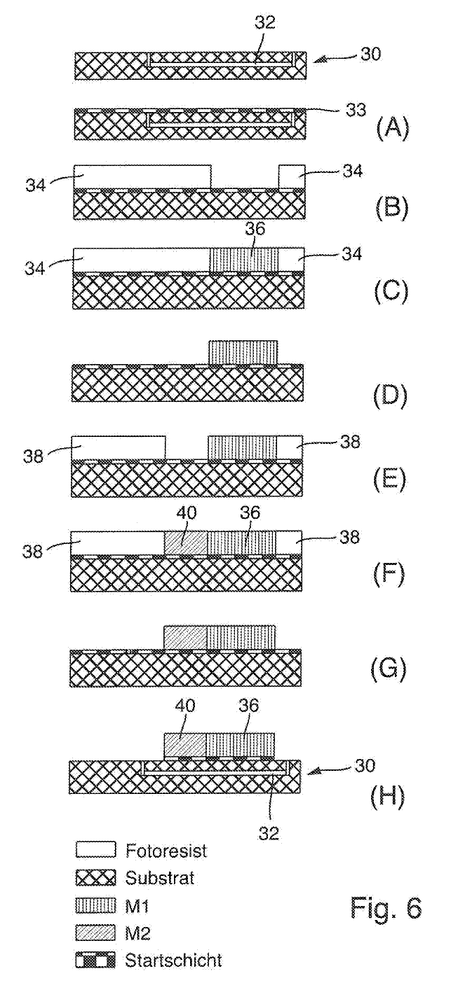

FIG. 6 shows a schematic representation of the method steps for the production of the magnetic core of FIG. 3.

The representation of FIG. 1 shows a magnetic core 10 according to the invention, which has been produced by thin-film technology on a substrate that is not represented. The magnetic core 10 has the form of a ring. Specifically, the magnetic core 10 has the form of a rectangular ring with rounded corners. The magnetic core 10 consists of altogether four portions 12, 14, 15 and 18. Seen in the circumferential direction or longitudinal direction of the magnetic core 10, the portions 12, 14, 16, 18 respectively form a portion of the length of the magnetic core. The portions 12, 14, 16, 18 lie with their ends directly against one another. The portions 12, 14, 16, 18 consequently form a continuous, uninterrupted ring.

The two portions 12, 16 consist in this case of a first magnetic material, for example nickel-iron (Ni—Fe). Nickel-iron may be used here in different alloys, for example NiFe 81/19, NiFe 45/55, etc. By contrast, the portions 14, 18 consist of a second magnetic material with different magnetic properties. For example, cobalt-iron (CoFe) or else other materials may be used here. For example, the use of nickel-iron both in the portions 12, 16 and in the portions 14, 18 is also possible, different alloys then being used, for example NiFe 81/19 in the portions 12, 16 and NiFe 48/58 in the portions 14, 18. The different magnetic materials for the portions 12, 14, 16, 18 may be selected for example from the group comprising the materials nickel (Ni), nickel-iron (NiFe), cobalt-iron (CoFe), cobalt-phosphorus (CoP) and cobalt-zirconium-titanium (CoZrTi).

The combination of two different magnetic materials in the magnetic core 10 allows the saturation of the magnetic core 10 to be set to a desired profile.

FIG. 2 shows, by way of example a diagram in which the inductance L is plotted as a function of the current I. The inductance L is plotted here as normalized, in order to show a typical profile irrespective of the coil surrounding the magnetic core. For comparison, the inductance L of a magnetic core with the dimensions of FIG. 1 and consisting exclusively of the material NiFe is represented in FIG. 2 by dashed lines. The inductance L of the magnetic core 10 of FIG. 1 with the portions 12, 16 then consisting of NiFe and the portions 14, 18 consisting of CoFe is then plotted in dotted lines. As is clearly evident, the magnetic core of FIG. 1 has a higher saturation throughout. This is achieved by the combination of the portions 12, 14, 16, 18 consisting of different magnetic materials, which then together form the segmented magnetic core 10.

By dividing the magnetic core 10 into portions 12, 14, 16, 18 of different materials, an improved saturation behavior can be achieved as a result. The desired properties can in this case be set by the geometrical dimensions of the portions 12, 14, 16, 18 and also by the choice of magnetic materials.

The representation of FIG. 3 shows a magnetic core 20 according to a further embodiment of the invention. Like the magnetic core 10 of FIG. 1, the magnetic core 20 has the form of a rectangular ring with rounded corners. As a difference from the magnetic core 10 of FIG. 1, the magnetic core 20 consists of an inner ring 22 of a first magnetic material and an outer ring 24 of a second magnetic material. The inner ring 22 is in this case directly adjacent with its outer side to the inner side of the outer ring 24. Consequently, portions of different magnetic materials are also combined with one another in the case of the magnetic core 20, the portions, that is to say the two rings 22, 24, respectively extending over the entire length of the magnetic core 20. For example, the inner ring 22 is produced from nickel-iron (NiFe), whereas the outer ring 24 is produced from cobalt-iron (CoFe).

The representation of FIG. 4 shows a diagram in which the normalized inductance L of the magnetic core 20 of FIG. 3 has been plotted against the current consumption. The dashed line represents the inductance of a magnetic core that consists exclusively of nickel-iron. In comparison with this, the inductance of the magnetic core 20 of FIG. 3 is plotted by a dotted line. It can be seen that the magnetic core 20 of FIG. 3 has a considerably improved saturation behavior. This is achieved by the combination of different magnetic materials in the inner ring 22 and in the outer ring 24. The saturation behavior of the magnetic core 20 can be made to suit the intended application by the geometrical dimensions of the inner ring 22 and of the outer ring 24 and also by the choice of magnetic materials for the inner ring 22 and the outer ring 24.

The representation of FIG. 5 schematically shows method steps for the production of an inductive component with the magnetic core 10 of FIG. 1 by thin-film technology.

The production process of the magnetic core begins with a substrate 30. The substrate 30 in this case already includes portions 32 of a coil winding that is likewise produced by thin-film technology. The substrate 30 consequently already includes the lower coil layer 32, and the magnetic core still to be produced is then located between the lower coil layer 32 and an upper coil layer (not represented).

In step A, a metallic starting layer 32 is applied to the substrate 30. As also in the case of the subsequent method steps, the lower coil layer 2 is no Longer depicted in the substrate 30 for the sake of overall clarity. The metallic starting layer 32 is applied for example by cathode sputtering methods. Nickel (Ni), titanium (Ti), tantalum (Ta), nickel-iron (NiFe) or copper (Cu) may be used as the starting layer.

In step B, a photoresist masking 34 is carried out, tee photoresist masking 34 then forming the mould for the subsequent electrodeposition of a first magnetic material.

In step C, the electrodeposition of the first magnetic material 36 is performed and the associated illustration shows the state after the completed deposition. The first magnetic material 36 then fills the inter spaces between the photoresist masking 34. With respect to FIG. 1, the portions 12, 16 of the magnetic core 10 are then formed by the first magnetic material 36. In the case of the embodiment represented, the first magnetic material is nickel-iron (NiFe).

In step D, the photoresist masking 34 is removed, so that only the first magnetic material 36 in the form of the portions 12, 16 is arranged on the metallic starting layer 32, see FIG. 1.

In production step E, a second photoresist masking 38 is applied, then forming a mould for the application of the second magnetic material. With respect to FIG. 1, the second photoresist masking 38 only leaves exposed the portions 14, 18, which are then cc be filled with the second magnetic material.

In production step F, the second magnetic material 40 is then deposited, then being directly adjacent to the first magnetic material 36. With respect to FIG. 1, the two portions 12, 14 of the first magnetic material 36 are then connected to one another by the two portions 14, 18 of the second magnetic material 40. In the case of the embodiment represented, the second magnetic material is cobalt-iron.

In a production step G, the second photoresist masking 38 is removed. Then arranged on the metallic starting layer 32 is the magnetic core 10, the portions 12, 16 of the first magnetic material 36 and the portions 14, 18 of the second magnetic material 40 then having been formed, as stated.

In method step H, the starting layer 32 is then removed in the regions in which it is not covered by the magnetic core 10. The starting layer 32 is in this case removed either by plasma etching, by ion beam etching or else by a wet-chemical process with acid.

After method step H, the finished magnetic core is consequently on the substrate 30. In further method steps, the inductive component can then be produced completely, in that the lower coil layer 32 is combined with an upper coil layer and lateral coil portions.

The representation of FIG. 6 schematically shows a number of production steps of the magnetic core 20 of FIG. 3.

The substrate 30 again includes a lower coil layer 32, which then, after production of the magnetic core 20, is completed with lateral coil portions and an upper coil layer to form a complete coil surrounding the magnetic core 20 in certain portions.

In production step A the application of the metallic starting layer 32 is performed,

In production step B, a first photoresist masking 34 is applied, the first photoresist masking 34 in this case forming the mould for the inner ring 22 of the magnetic core 20 of FIG. 3. In the representation belonging to method step B, and also in the subsequent representations, the lower coil layer 32 is no longer represented for the sake of overall clarity.

In production step C, the first magnetic material 36 is then elect redeposited and then forms the inner ring 22, see FIG. 3.

In production step D, the first photoresist masking 34 is removed.

In production step E, the second photoresist masking 38 is applied and then forms the mould for the outer ring 24 of the magnetic core 20 of FIG. 3.

In production step F, the second magnetic material 40 is deposited, is then directly adjacent to the first magnetic material 36 and then forms the outer ring 24 of the magnetic core 20 of FIG. 3. It should be stated in this respect that the representations of FIG. 6 are schematic, and only a section through the magnetic core 20 is represented, in order to illustrate the successive method steps.

In method step G, the second photoresist masking 38 is removed.

In method step H, the metallic starting layer. 33 is then removed in the regions in which it is not covered by the first magnetic material 36 or the second magnetic material 40. Consequently, only the magnetic core 20 remains arranged on the substrate 30, see FIG. 3. The lower coil layer 32 can then be added in the subsequent method steps to complete a coil surrounding the magnetic core 20 in certain portions.

The invention is used for microtechnical inductive components, for example storage inductors and transformers for high switching frequencies, as are used in particular in the case of DC-DC converters. The possibility of being able to set the saturation behavior of the magnetic cores 10, 20 that are used to a desired saturation behavior offers considerable advantages for these.

1. A magnetic core for an inductive component, produced by thin-film technology, characterized in that the magnetic core (10, 20) consists of at lease two different magnetic materials (36, 40).

2. The magnetic core as claimed in claim 1, characterized in that, seen over the length of the magnetic core (10), the different magnetic materials (36, 40) alternate.

3. The magnetic core as claimed in claim 1, characterized in that the different magnetic materials (36, 40) respectively take up the complete cross section of the magnetic core (10).

4. The magnetic core as claimed in claim 1, characterized in that the different magnetic materials (36, 40) respectively extend over the entire length of the magnetic core (20).

5. The magnetic core as claimed in claim 4, characterized in that a cross section of the magnetic core (20) is formed from different, magnetic materials (36, 40).

6. The magnetic core as claimed in claim 1, characterized in that the magnetic core (10, 20) forms a closed ring, the ring having a circular, oval, elliptical, square or rectangular form.

7. The magnetic core as claimed in claim 6, characterized in that the magnetic core (20) is formed by means of at least an inner ring (22) of a first magnetic material (36) and an outer ring (24) of a second magnetic material (40).

8. The magnetic core as claimed in claim 1, characterized in that the different magnetic materials are selected from the materials Ni, NiFe, CoFe, CoP and CoZrTi.

9. An inductive component with a magnetic core as claimed in claim 1, a coil surrounding the magnetic core (10, 20) in certain portions being produced by means of thin film technology.

10. A method for producing a magnetic core (10, 20) as claimed in claim 1, characterized by application of a first magnetic material (36) to a substrate (30) by means of thin-film technology and application of a second magnetic material (40) to the substrate (30) by means of thin-film technology, the first magnetic material (36) being directly adjacent to the second magnetic material (40) at least in certain portions.

11. The method as claimed in claim 10, characterized in that the application of the second magnetic material (40) has the effect of forming a closed ring comprising the first magnetic material (36) and the second magnetic material (40).

12. The method as claimed in claim 10, characterized in that the first magnetic material is applied to the substrate (30) in the form of a first closed ring (22) and the second magnetic material (40) is applied to the substrate (30) in the form of a second closed ring (24), the second closed ring (24) being directly adjacent to the first closed ring (22) with one side.

13. The method as claimed in claim 10, characterized by application of a portion (32) of a coil winding to the substrate (30) by thin-film technology, followed by application of the first and second magnetic material (36, 40) to form the magnetic core (10, 20) and then application of further portions of the coil winding, so that the finished coil winding surrounds the magnetic core (10, 20) in certain portions.
